(19) United States
(12) Patent Application Publication
(10) Pub. No.: US 2025/0114727 A1
(43) Pub. Date: Apr. 10, 2025

(54) FILTER ELEMENT, FILTER SYSTEM, AND METHOD FOR PRODUCING A FILTER ELEMENT

(71) Applicant: MANN+HUMMEL GmbH, Ludwigsburg (DE)

(72) Inventor: Christine OPRISCH, Oberriexingen (DE)

(21) Appl. No.: 18/905,241

(22) Filed: Oct. 3, 2024

(30) Foreign Application Priority Data
Oct. 4, 2023 (DE) 102023127009.5

(51) Int. Cl. B01D 29/21

(52) U.S. Cl. CPC B01D 29/21; B01D 2201/0415

(57) ABSTRACT

A filter element for fluid has first and second end disks spaced apart in longitudinal direction. A filter medium body with closed circumference is seal-tightly arranged between the end disks and encloses an interior in which a support element is arranged which has a projection with an axial safety device. The first end disk has a socket extending in longitudinal direction away from the filter medium body and provided with an axial safety device. The projection with axial safety device projects into the socket with axial safety device, and the axial safety devices are operatively connected to each other. The second end disk has an annular element projecting into the interior of the filter medium body and provided with a contour. The contour and a counter contour at the support element form an end stop of the second end disk when connecting filter medium body and second end disk.

### CROSS-REFERENCE TO RELATED APPLICATIONS

This patent application claims the priority of the German patent application with the serial number 10 2023 127 009.5 which was filed on Oct. 4, 2023, in the German Patent and Trademark Office and whose contents is hereby incorporated by reference.

### BACKGROUND

The invention concerns a filter element, a filter system as well as a method for producing a filter element, for example, a filter element for a urea-water solution.

EP 1593419 A1 discloses a filter element for the installation in a liquid filter, in particular for a urea-water solution. The filter element is arranged in a housing pot, wherein a housing cover is screwed seal-tightly to the housing pot. The filter element comprises a first end disk and a second end disk, wherein a pleated filter medium is inserted between the end disks. The end disks are connected to each other by a support element, wherein the support element prevents radial relative movements between the end disks. In this context, the support element is formed as one piece together with the second end disk. In axial direction, the support element comprises snap hooks which captively connect the first end disk to the second end disk. Due to this connection, the second end disk can be safely removed from the housing pot by pulling on the first end disk.

WO 2006/010987 A1 discloses a filter element in which an end disk projects with snap hooks into cutouts of the support element of the filter element.

DE 10 2014 015 613 A1 discloses a hollow filter element with a central tube and a multi-part fixation device for axial fixation at the first end disk and a connection device for snap-connecting to the second end disk.

### SUMMARY

It is an object of the invention to provide an improved filter element which can be produced in a beneficial manner.

A further object resides in providing a filter system provided with such a filter element.

A further object resides in providing a method for producing such a filter element.

The aforementioned objects are solved according to an aspect of the invention by a filter element for cleaning a fluid, for example, a urea-water solution, comprising a first, in particular open, end disk and a second, in particular closed, end disk which are spaced apart from each other in a longitudinal direction, wherein between the end disks a filter medium body with a filter medium with a closed circumference is seal-tightly arranged which encloses an interior, wherein in the interior a support element is arranged which comprises an axial safety device for an operative connection to an axial safety device of the first end disk, wherein the support element projects with a projection provided with its axial safety device into a socket provided with the axial safety device of the first end disk and extending away from the filter medium body in the longitudinal direction. The second end disk comprises an annular element (socket) projecting into the interior and comprising a contour which forms with a counter contour of the support element an end stop of the second end disk when connecting the filter medium body to the second end disk.

According to a further aspect of the invention, the objects are solved by a filter system, for example for urea-water solutions, with a filter element according to the invention, with a housing comprising an inlet and an outlet, wherein the housing comprises a housing pot and a housing cover, wherein the filter element is seal-tightly arranged between inlet and outlet.

According to a further aspect of the invention, the objects are solved by a method for producing a filter element according to the invention, characterized by providing an in particular pleated filter medium body with a closed circumference which encloses an interior; providing a support element with a damper receiving region and a body receiving region; inserting a displacement body into the body receiving region in the interior of the support element; mounting a damper element at the damper receiving region at an outer side of the support element; inserting the support element into the interior of the filter medium body with displacement body in the body receiving region in the interior of the support element and with damper element at the damper receiving region; positioning a first end disk at an end face and a second end disk at an oppositely positioned end face of the filter medium body; as well as joining first end disk, filter medium body, and second end disk by the action of a welding process, in particular of a hot plate welding process, until the filter medium body is seal-tightly fused with its end faces to the end disks.

Beneficial embodiments and advantages of the invention result from the additional claims, the description, and the drawing.

According to an aspect of the invention, a filter element for cleaning a fluid, in particular a urea-water solution, is proposed, comprising a first, in particular open, end disk and a second, in particular closed, end disk, which are spaced apart from each other in a longitudinal direction. Between the end disks, a filter medium body with a filter medium with a closed circumference is seal-tightly arranged which encloses an interior, wherein in the interior a support element is arranged which comprises an axial safety device for an operative connection to an axial safety device of the first end disk. The support element projects with a projection provided with its axial safety device into a socket provided with the axial safety device of the first end disk and extending away from the filter medium body in longitudinal direction. The second end disk comprises an annular element projecting into the interior and provided with a contour which forms with a counter contour of the support element an end stop of the second end disk when connecting the filter medium body to the second end disk.

Advantageously, joining the end disks to a filter medium, for example by means of infrared welding or hot plate welding, can be realized in one process step. At the end facing the first end disk, the support element can comprise a shoulder which serves as an end stop for the first end disk when the latter is guided toward the filter medium body. Upon joining of filter medium body and end disks, the second end disk can lock with its contour at the counter contour of the support element so that, on the one hand, a fixed end stop for the second end disk is provided and a stable fixation of the support body at the second end disk is achieved at the same time. At the first end disk, in case of a length extension of the filter medium body, the axial safety device can limit effectively an excessive expansion of the filter medium body. The axial safety device of the projection of the support element can be present, for example, in the form of one or a plurality of radially outwardly oriented hooks. The axial safety device of the first end disk can be, for example, a radially inwardly oriented shoulder at which the radially outwardly oriented hooks can get hooked when the end disk, due to a length increase of the filter medium body, for example, upon liquid uptake by the filter medium, moves in the direction of the hooks. Optionally, the axial safety device of the first end disk can be formed by one or a plurality of cutouts at the inner side of the socket of the first end disk.

According to a beneficial embodiment of the filter element, the support element can engage across the annular element of the second end disk. In particular, the support element can engage with its counter contour across the contour of the annular element of the second end disk. The contour can then engage, from a radially outward position, in the radially outwardly facing counter contour of the annular element. Contour and/or counter contour can be arranged on teeth, respectively. This has the advantage that upon joining of support element and second end disk a sufficient flexibility of the teeth is present so that the second end disk with its annular element (socket) can be pushed into the support element until contour and counter contour are connected. Contour and counter contour can form a form fit connection, for example.

According to a beneficial embodiment of the filter element, contour and counter contour can form a catch connection. The contour, for example, can be a rounded protrusion and the counter contour a groove. The contour in the form of the rounded protrusion can contact form-fittingly the groove.

According to a beneficial embodiment of the filter element, the support element, at the second end disk, can comprise in its interior a body receiving region for at least one displacement body. When filtering a liquid which can freeze at low temperatures, the volume can greatly increase due to the solidifying liquid. The displacement body can be compressed by the solidifying liquid and compensates the volume change of the liquid in this way in case of dropping temperatures. In this way, damage to the filter element and/or the filter system is prevented.

According to a beneficial embodiment of the filter element, the displacement body can be formed of an elastomer. In particular, the displacement body can be formed of EPDM (ethylene propylene diene rubber). Beneficially, the displacement body with its elastic properties can be inserted easily into the body receiving region. Furthermore, the displacement body can be reversibly compressed as needed when the fluid to be filtered freezes and melts again.

According to a beneficial embodiment of the filter element, the support element can comprise between the second end disk and the first end disk a damper receiving region for receiving at least one damper element. In particular, the damper receiving region can receive at its outer side the at least one damper element. For example, the at least one damper element can be placed around the damper receiving region or can be clipped around the damper receiving region. The at least one damper element can be designed such that it reaches inwardly through the support element at least in sections. Here, one can take advantage of the support element usually having a grid-type wall so that passageways are present in the support element through which the at least one damper element can reach. In particular, the damper receiving region can be arranged between the body receiving region and the first end disk. Advantageously, the damper receiving region can be arranged adjacent to the body receiving region. The damper receiving region can advantageously reduce or prevent undesirable movements of a heating element, for example, of a heating rod, inserted into the interior of the support element. In this way, damages of the filter element in operation due to vibrations of the filter element and/or of the heating rod can be reduced or prevented. At the same time, an inserted heating element can be protected from surface damages by friction.

According to a beneficial embodiment of the filter element, the damper element can be designed as a slotted ring. The damper element can be clipped easily into the damper receiving region. In particular, the damper element can be designed as a slotted ring which reaches inwardly with protrusions through passageways in the support element from an outer side of the support element. In this way, the damper element can surround, for example, a heater in the interior of the support element. Reaching inwardly through the passageways secures furthermore the damper element in its position in the damper receiving region.

According to beneficial embodiment of the filter element, the damper element can be formed of an elastomer. In particular, the damper element can be formed of EPDM. Beneficially, the damper element with its elastic properties can be inserted easily into the damper receiving region. Furthermore, the damper element as needed can be compressed reversibly when the fluid to be filtered freezes and then melts again. The damper element can have a smooth surface while it comprises pores in the interior.

According to a beneficial embodiment of the filter element, the filter medium of the filter medium body can be embodied fully synthetically. Such a filter medium is beneficial, for example, for filtering a urea-water mixture.

According to a further aspect of the invention, a filter system, in particular for urea water solutions, with a filter element according to the invention is proposed, with a housing comprising an inlet and an outlet, wherein the housing comprises a housing pot and a housing cover, wherein the filter element is arranged seal-tightly between inlet and outlet.

Beneficially, a length increase of the filter medium body in operation outside of permissible tolerances can be limited even in case of a relatively long filter medium body.

According to a beneficial embodiment of the filter system, a heating element, in particular a heating rod, can be inserted into the interior of the filter medium body, wherein a free end of the heating element is surrounded by a damper element which is arranged at a support element of the filter element. Advantageously, undesirable movements of the filter element about the heating element in operation can be reduced or prevented.

According to a further aspect of the invention, a method for producing a filter element according to the invention is proposed, characterized by providing an in particular pleated filter medium body with a filter medium with a closed circumference which encloses an interior; providing a support element with a damper receiving region and a body receiving region; inserting a displacement body into the body receiving region in the interior of the support element; mounting a damper element at the damper receiving region at an outer side of the support element; inserting the support element into the interior of the filter medium body with the displacement body in the body receiving region in the interior of the support element and with the damper element at the damper receiving region; positioning a first end disk at an end face and a second end disk at an oppositely positioned end face of the filter medium; as well as joining first end disk, filter medium body, and second end disk by the action of a welding process, in particular a hot plate welding process, until the filter medium body with its end faces is seal-tightly fused to the end disks.

Advantageously, joining of end disks and filter medium body can be realized in one process step. It can be prevented that the filter medium body is compressed too strongly.

According to a beneficial embodiment of the method, an operative connection of a contour of the second end disk and a counter contour of the support element can serve as an end stop for the second end disk during the welding process. A length of the filter element can be produced within permissible manufacturing tolerances.

Since the support element is provided already with the displacement body and the damper element prior to joining, mounting of these components can be simplified.

According to a beneficial embodiment of the method, the support element can be clipped to the second end disk during the welding process in that a contour of the second end disk and a counter contour of the support element are pushed onto each other during joining of end disk and filter medium. Advantageously, the contour and the counter contour together can form a form fit connection.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a view of a longitudinal section of a filter element according to an embodiment of the invention.

FIG. 2 shows in the manner of an exploded illustration a view of components of the filter element according to FIG. 1.

FIG. 3 shows a perspective view of a support element of the filter element according to FIG. 1.

FIG. 4 shows a perspective view of a displacement body of a filter element according to FIG. 1.

FIG. 5 shows a perspective view of a damper element of a filter element according to FIG. 1.

FIG. 6 shows a perspective view of a first end disk of a filter element according to FIG. 1.

FIG. 7 shows a perspective view of a second end disk of a filter element according to FIG. 1.

FIG. 8 shows a perspective view of a partially cutaway filter element according to FIG. 1 with inserted heating element.

FIG. 9 shows a longitudinal section through a simplified filter system with the filter element according to FIG. 8 with inserted heating element.

FIG. 10 shows a process sequence for producing a filter element according to an embodiment of the invention.

### DETAILED DESCRIPTION

In the Figures, same or same-type components are identified with the same reference characters. The Figures show only examples and are not to be understood as limiting.

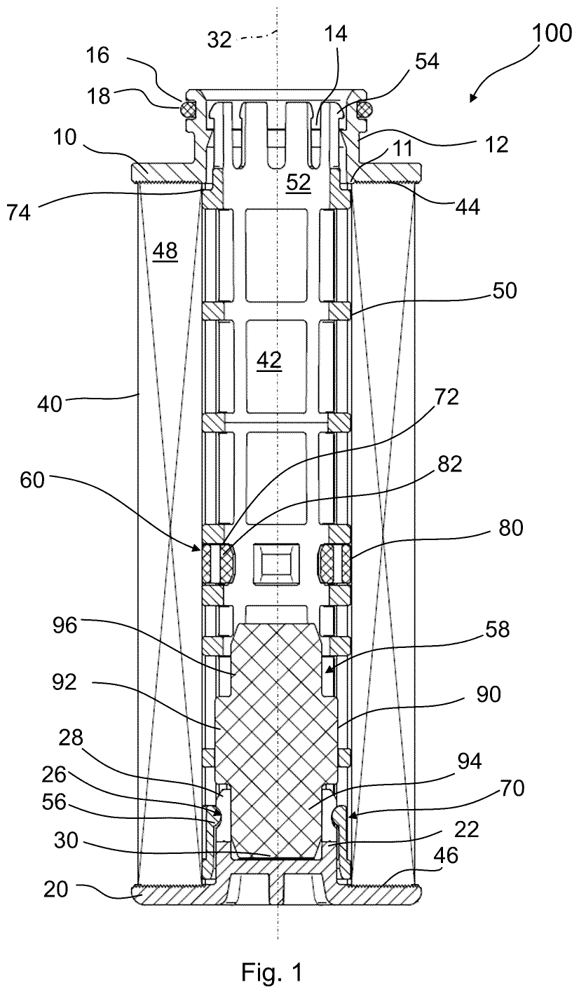

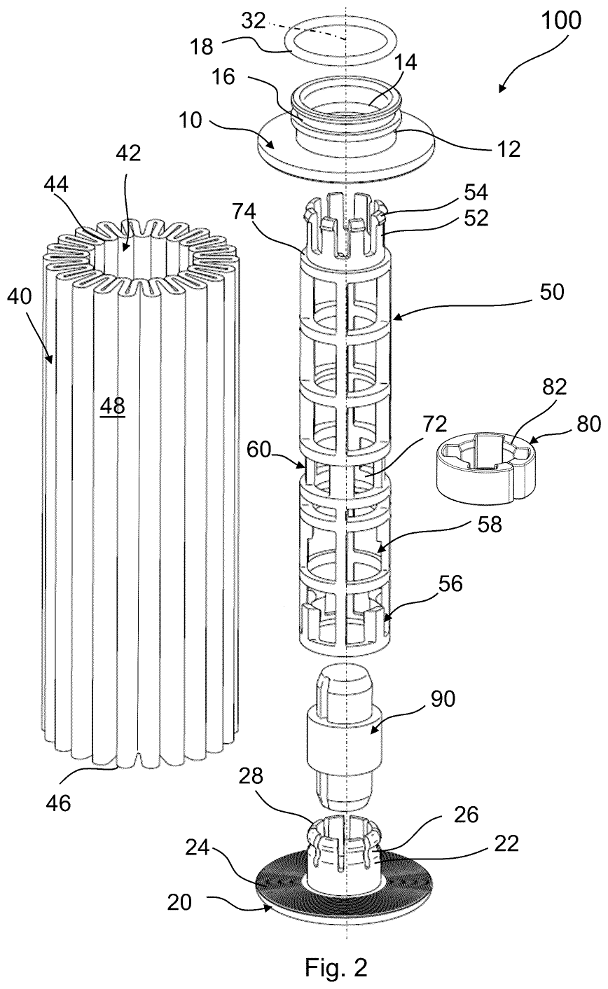

FIG. 1 shows a view of a longitudinal section of the filter element 100 according to an embodiment of the invention. FIG. 2 shows in the manner of an exploded illustration a view of components of the filter element 100 according to FIG. 1.

The filter element 100 serves for cleaning a fluid, in particular a urea-water solution. The filter element 100 comprises a first end disk 10 and a second end disk 20 which are spaced apart from each other in a longitudinal direction 32. The first end disk 10 is embodied, for example, as an open end disk 10 and a second one as a closed end disk 20, for example.

Between the two end disks 10, 20, a filter medium body 40 with a filter medium 48 with a closed circumference is seal-tightly arranged and encloses an interior 42.

The filter medium 48 can be in particular of fully synthetic material. In case of a fluid to be filtered in the form of a urea-water solution, such a filter medium 48 exhibits a length increase which may impair the integrity of the filter element 100.

In the interior 42, a support element 50 is arranged which comprises an axial safety device 54 for operative connection to an axial safety device 14 of the first end disk 10. The support element 50 comprises webs as well as passageways 72 through which the fluid can pass.

The axial safety device 54 can be in the form of outwardly facing hooks in longitudinal direction 32 and projects at a projection 52 of the support element 50 into a socket 12 which is provided with the axial safety device 14 of the first end disk 10 and extends in longitudinal direction 32 away from the filter medium body 40. The axial safety device 14 of the first end disk 10 can be in particular an inwardly facing shoulder in the socket 12.

When the filter medium 48 expands, the hooks of the support element 50 can catch at the shoulder and prevent a further length increase.

When mounting the first end disk 10, axial safety device 14 of the first end disk can be pushed easily across the axial safety device 54 of the support element 50 embodied as hooks. In this context, the shoulder at its underside can comprise a slant so that the hooks can easily glide across the shoulder.

The projection 52 of the support element 50 comprises a reduced diameter in comparison to the adjoining region of the support element 50 so that a circumferential shoulder 74 is formed which serves as an end stop for the first end disk 10 during mounting.

The second end disk 20 comprises an annular element 22 projecting into the interior 42 and provided with a contour 26 which forms with a counter contour 56 of the support element 50 an end stop 70 of the second end disk 20 when connecting the filter medium body 40 to the second end disk 20.

The support element 50 engages in this context across the annular element 22 of the second end disk 20. In particular, the support element 50 can engage with its counter contour 56 across the contour 26 of the annular element 22 of the second end disk 20. In this context, the contour 26 and the counter contour 56 form a catch connection. The counter contour 56 of the support element 50 can comprise teeth 55 which are oriented in the direction of projection 52 of the support element 50 and which comprise an inwardly oriented bulge.

The contour 26 of the second end disk can also comprise teeth 28 which comprise an outwardly oriented complementary structure, in particular a groove. The contour 26 and the counter contour 56 can form a form fit connection so that the second end disk 20 and the support element 50 are connected stably to each other.

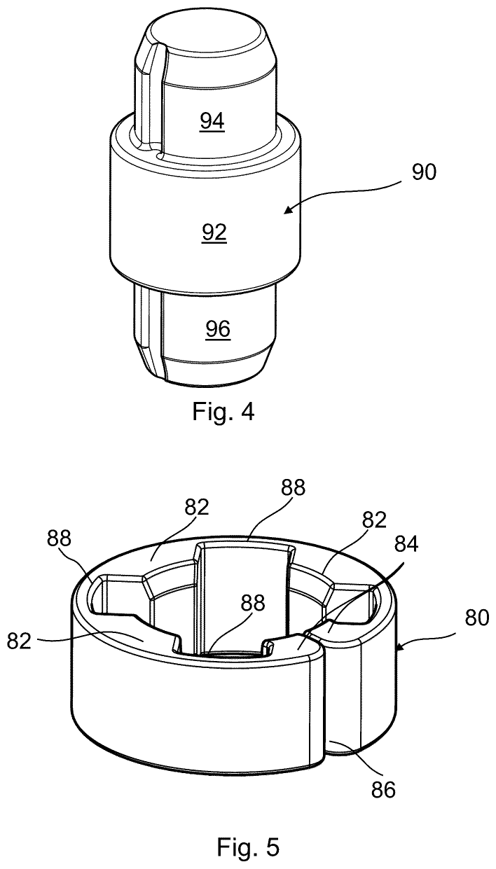

At the end facing the second end disk 20, the support element 50 comprises in its interior a body receiving region 58 for at least one displacement body 90 which is illustrated in perspective in FIG. 4.

The displacement body 90 is preferably made of an elastomer, in particular of EPDM. The displacement body 90 comprises a cylinder region 92 from which a pin 94, 96 extends away in both directions, respectively (FIG. 4). The pins 94, 96 have a notch that enables air to escape which would be compressed underneath the displacement body 90 during mounting when the displacement body 90 is pushed into the second end disk 20.

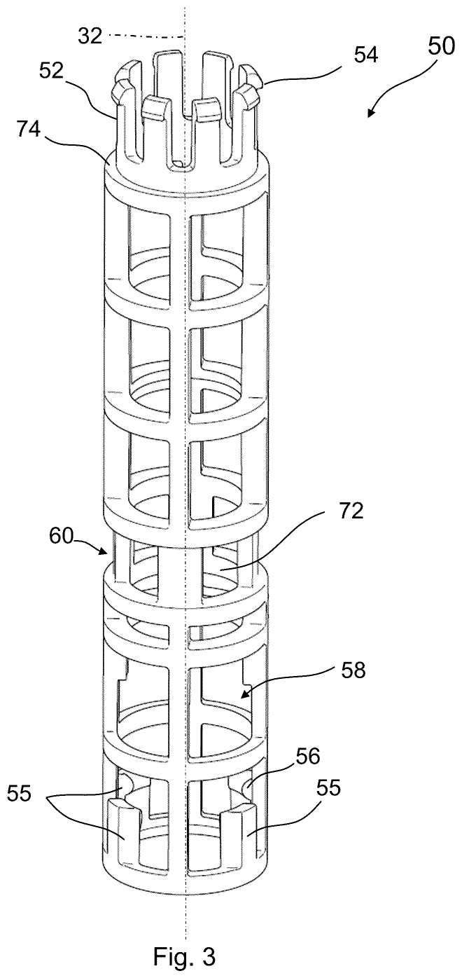

FIG. 3 shows a perspective view of the support element 50 of the filter element 100 according to FIGS. 1 and 2.

In the direction of the projection 52 of the support body 50, the body receiving region 58 is configured complementary to the displacement body 90 so that the displacement body 90 can be easily pushed into the interior of the support body, until the cylinder region 92 impacts on a shoulder of the support element 50 which is not identified in detail.

The damper receiving region 60 adjoins the body receiving region 58 and is embodied at the outer side of the support element 50 in the form of a constriction. A damper element 80 can be inserted into the damper receiving region 60.

The damper element 80 is illustrated in detail in FIG. 5. The damper element 80 is designed as a slotted ring and comprises inwardly facing wedge-type protrusions 82. At the slot 86 of the damper element 80, a protrusion 84 divided into two halves is provided. When the damper element 80 is placed around the support element 50 in the damper receiving region 60, the protrusions 82 and the divided protrusion 84 can reach inwardly through the passageways 72 in the support element 50 from the outer side of the support element 50. The damper element 80 is therefore axially secured. At the same time, the slot 86 is secured by the passageway 72 and cannot open.

In the mounted state, the connections 88 between the protrusions 82 and 84 are sufficiently spaced apart from webs of the support element 50 so that a sufficient gap for the fluid remains.

The protrusions 82, 84 project into the interior of the support element 50 so that an element in the support element 50, for example, a heating element, can be stabilized by the damper element 80 in radial direction.

The damper element 80 is formed of an elastomer, which may be EPDM.

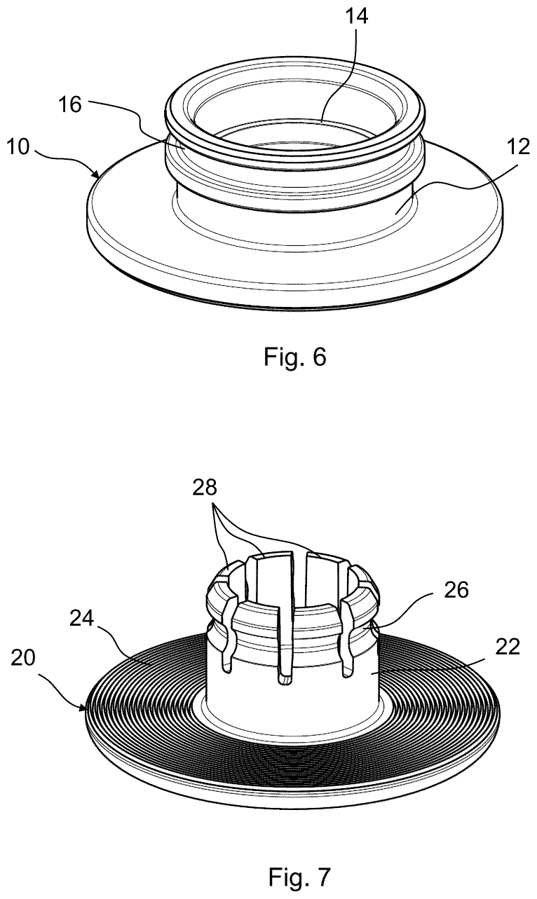

FIG. 6 shows a perspective view of the first end disk 10 of the filter element 100 according to FIG. 1. The socket 12 of the first end disk 10 comprises the shoulder as an axial safety device 14 in the interior. At its outer side, the socket 12 comprises a groove 16 for receiving a seal ring 18 (FIGS. 1, 2, 8).

FIG. 7 shows a perspective view of the second end disk 20 of the filter element 100 according to FIG. 1. At its inner side, the second end disk 20 comprises a concentric groove structure 24 which is advantageous for joining to the filter element 40.

Such a groove structure is expediently also present at the first end disk 10.

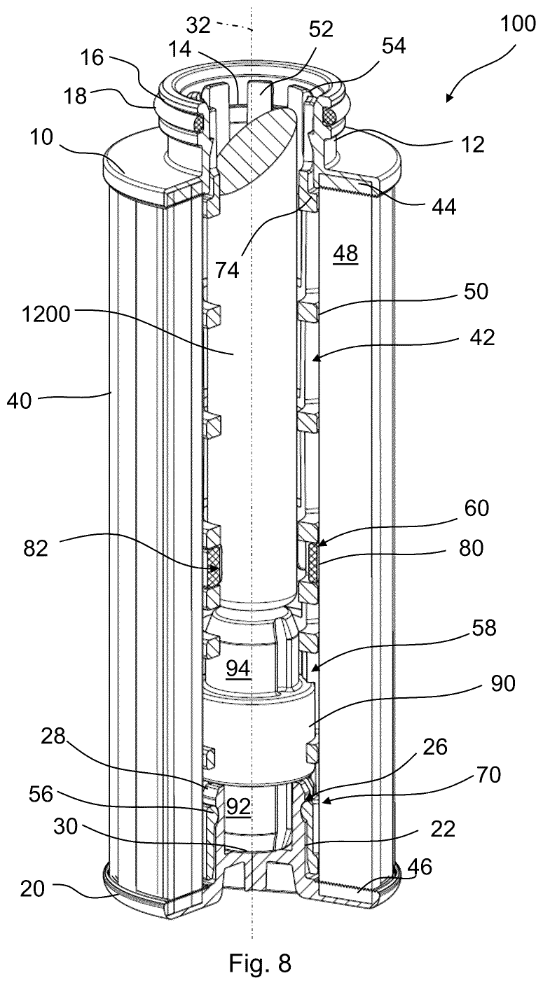

FIG. 8 shows a perspective view of a partially cutaway filter element 100 according to FIG. 1 with inserted partially cutaway heating element 1200. The heating element 1200 projects from the first end disk 10 into the interior of the support element 50 and is supported at its free end in radial direction by the damper element 80 and its protrusions 82, 84. When in operation of the filter element 100 vibrations occur, the heating element 1200 is limited in its radial movability and the filter medium body 40 and the support element 50 are protected from damages.

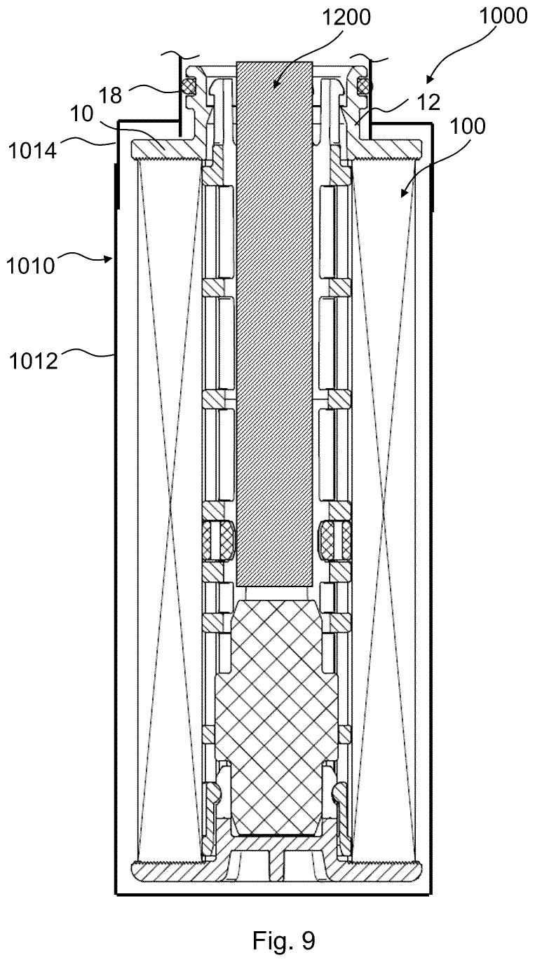

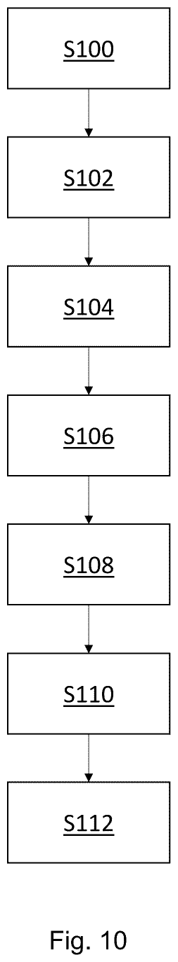

FIG. 9 shows a longitudinal section through a filter system 1000, illustrated in a simplified manner, with the filter element 100 according to FIG. 8 with inserted heating element 1200.

The filter system 1000 comprises a housing 1010 with a housing pot 1012 and a housing cover 1014, with an inlet and an outlet for the fluid, not illustrated, wherein the filter element 100 is arranged seal-tightly between inlet and outlet.

The filter element 100 is arranged in the housing pot 1012 and is inserted with the socket 12 of the first end disk 10 into the housing cover 1014 upon closing the housing 1010, wherein the seal ring 18 seals against the housing cover 1014. Housing cover 1014 and housing pot 1012 can be screwed together, for example.

FIG. 10 shows a process sequence for producing a filter element 100 according to an embodiment of the invention.

In step S100, providing of an in particular pleated filter medium body 40 with a closed circumference which encloses an interior 42 is realized.

In step S102, providing of a support element 50 with a damper receiving region 60 and a body receiving region 58 is realized.

In step S104, inserting of a displacement body 90 into the body receiving region 58 in the interior of the support element 50 in the region where the second end disk 20 is to be fastened is realized.

In step S106, mounting of a damper element 80 at the damper receiving region 60 at an outer side of the support element 50 is realized.

Inserting of the displacement body 90 and mounting of the damper element 80 can be realized also in reverse order.

In step S108, inserting of the support element 50 into the interior 42 of the filter medium 40 with displacement body 90 in the body receiving region 58 in the interior of the support element 50 and damper element 80 at the damper receiving region 60 is realized.

In step S110, positioning of a first end disk 10 at an end face 44 and of a second end disk 20 at an oppositely positioned end face 46 of the filter medium 40 is realized.

In step S112, joining of first end disk 10, filter medium 40, and second end disk 20 by the action of a welding process, in particular a hot plate welding process, is realized until the filter medium 40 with its end faces 44, 46 is seal-tightly fused to the end disks 10, 20.

During the welding process, an operative connection of a contour 26 of the second end disk 20 and of a counter contour 56 of the support element 50 serves as an end stop for the second end disk 20. In this context, the support element 50 is clipped to the second end disk 20 during the welding process in that the contour 26 of the second end disk 20 and the counter contour 56 of the support element 50 are pushed onto each other upon joining of end disk 20 and filter medium 40.

### REFERENCE CHARACTERS

10 end disk
11 edge
12 socket
14 axial safety device
16 seal groove
18 seal ring
20 end disk
22 annular element (socket)
24 groove structure
26 contour
28 tooth
30 seat
32 longitudinal direction
40 filter medium body
42 interior
44 end face
46 end face
48 filter medium
50 support element
52 projection
54 axial safety device
55 tooth
56 counter contour
58 body receiving region
60 damper receiving region
70 end stop
72 passageway
74 shoulder
80 damper element
82 protrusion
84 divided protrusion
86 gap
90 displacement body
92 cylinder region
94 pin
96 pin
100 filter element
1000 filter system
1010 housing
1012 pot
1014 cover
1200 heating element
S100 providing
S102 providing
S104 inserting
S106 mounting
S108 inserting
S110 positioning
S112 joining

What is claimed is:

1. A filter element for cleaning a fluid, the filter element comprising:
a first end disk and a second end disk, wherein the first end disk and the second end disk are spaced apart from each other in a longitudinal direction of the filter element;
a filter medium body comprising a filter medium and a closed circumference, wherein the filter medium body is seal-tightly arranged between the first end disk and the second end disk, wherein the filter medium body encloses an interior;
a support element arranged in the interior of the filter medium body, wherein the support element comprises a projection and an axial safety device arranged at the projection;
wherein the first end disk comprises a socket and an axial safety device arranged at the socket, wherein the socket of the first end disk extends in the longitudinal direction away from the filter medium body;
wherein the projection of the support element provided with the axial safety device of the support element projects into the socket of the first end disk provided with the axial safety device of the first end disk, wherein the axial safety device of the support element and the axial safety device of the first end disk are operatively connected to each other;
wherein the second end disk comprises an annular element projecting into the interior of the filter medium body, wherein the annular element comprises a contour;
wherein the support element comprises a counter contour;
wherein the contour of the annular element and the counter contour of the support element form an end stop of the second end disk when connecting the filter medium body to the second end disk.

2. The filter element according to claim 1, wherein the support element engages across the annular element of the second end disk.

3. The filter element according to claim 2, wherein the counter contour of the support element engages across the contour of the annular element of the second end disk.

4. The filter element according to claim 1, wherein the contour of the annular element and the counter contour of the support element form a catch connection.

5. The filter element according to claim 1, wherein the support element comprises a body receiving region configured to receive at least one displacement body in an interior of the support element, wherein the body receiving region is arranged at an end of the support element facing the second end disk.

6. The filter element according to claim 5, wherein the at least one displacement body is formed of an elastomer.

7. The filter element according to claim 1, wherein the support element comprises a damper receiving region configured to receive at least one damper element, wherein the damper receiving region is arranged between the second end disk and the first end disk.

8. The filter element according to claim 7, wherein the support element comprises a body receiving region configured to receive at least one displacement body in an interior of the support element, wherein the body receiving region is arranged at an end of the support element facing the second end disk, wherein the damper receiving region is arranged between the body receiving region and the first end disk.

9. The filter element according to claim 7, wherein the damper receiving region is arranged at an outer side of the support element.

10. The filter element according to claim 7, wherein the at least one damper element is a slotted ring.

11. The filter element according to claim 10, wherein the slotted ring comprises protrusions reaching inwardly through passageways of the support element from an outer side of the support element.

12. The filter element according to claim 7, wherein the at least one damper element is formed of an elastomer.

13. The filter element according to claim 1, wherein the filter medium is fully synthetic.

14. A filter system comprising:
a housing comprising an inlet and an outlet;
wherein the housing comprises a housing pot and a housing cover;
a filter element according to claim 1 arranged seal-tightly between the inlet and the outlet in the housing.

15. The filter system according to claim 14, further comprising a heating element inserted into the interior of the filter medium body of the filter element, wherein the filter element comprises a damper element arranged at the support element of the filter element, wherein the damper element surrounds a free end of the heating element.

16. A method for producing a filter element, the method comprising:
providing a filter medium body comprising a closed circumference and enclosing an interior;
providing a support element comprising a damper receiving region and further comprising a body receiving region;
inserting a displacement body into the body receiving region in an interior of the support element;
mounting a damper element at the damper receiving region at an outer side of the support element;
inserting the support element, provided with the displacement body in the body receiving region in the interior of the support element and provided with the damper element mounted at the damper receiving region, into the interior of the filter medium body;
positioning a first end disk at a first end face of the filter medium body and a second end disk at a second end face of the filter medium body positioned opposite the first end face;
joining the first end disk, the filter medium body, and the second end disk by a welding process until the first end face and the second end face of the filter medium body are seal-tightly fused to the first end disk and the second end disk, respectively.

17. The method according to claim 16, using a hot plate welding process as the welding process.

18. The method according to claim 16, further comprising providing an operative connection of a contour of the second end disk and of a counter contour of the support element as an end stop for the second end disk during the welding process.

19. The method according to claim 16, further comprising clipping the support element to the second end disk during the welding process by pushing a contour of the second end disk and a counter contour of the support element onto each other when joining the second end disk and the filter medium body.
